(19) United States
(12) Patent Application Publication
(10) Pub. No.: US 2010/0178446 A1
(43) Pub. Date: Jul. 15, 2010

(54) RECORDING LAYER FOR OPTICAL RECORDING MEDIUM, SPUTTERING TARGET, AND OPTICAL RECORDING MEDIUM

(75) Inventors: Hideo Fujii, Hyogo (JP); Hironori Kakiuchi, Hyogo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Kobe Seiko Sho(Kobe Steel, Ltd.), Kobe-shi (JP)

(21) Appl. No.: 12/376,484

(22) PCT Filed: Aug. 7, 2007
(86) PCT No.: PCT/JP07/65413

§ 371 Date: Feb. 5, 2009

(30) Foreign Application Priority Data
Aug. 8, 2006 (JP) 2006-215754
Feb. 8, 2007 (JP) 2007-029612
May 11, 2007 (JP) 2007-126210

(51) Int. Cl. B32B 3/02

(52) U.S. Cl. 428/64.4

(57) ABSTRACT

Recording marks are formed in a recording layer by irradiation with a laser beam. The recording layer is made of an In-base alloy containing Ni and/or Co in a content in the range of 20 to 65 at %. Another recording layer is made of an In-base alloy containing Ni and/or Co, and containing at least one of Sn, Bi, Ge and Si in a content of 19 at % or below excluding 0 at %. An optical recording medium is provided with either of the foregoing recording layers. A sputtering target is used for forming the recording layer. The recording layer of the optical recording medium has a high reflectivity (initial reflectivity), a high C/N ratio and a low jitter.

### TECHNICAL FIELD

The present invention relates to a recording layer for an optical recording medium (particularly, a write-once optical disk to which information is written with a violet laser beam), an optical recording medium, and a sputtering target for forming the recording layer of an optical recording medium.

### BACKGROUND ART

Studies are made of recording layers of write-once optical disks to which information is written with a violet laser beam. Those recording layers are roughly classified into thin films of organic dyes and thin films of an inorganic material. Organic dyes have been practically used for forming conventional optical disks, such as CD-Rs and DVD-Rs, to which information is written with a red laser beam. Organic dyes that can be used in combination with a violet laser beam have a problem in light resistance. Therefore, most studies of recording layers of BD-Rs relate with inorganic thin films.

Known recording methods include 1) phase-change recording methods that change the phase of an inorganic thin film by irradiation with a laser beam, 2) hole creating methods and 3) interlayer reaction recording methods

The phase-change recording method uses a recording film of an oxide or a nitride. Proposed in Patent document 1 is Te—O-M (M is at least one of metals, metalloids and semiconductors.

The hole creating method uses a recording film of a metal having a low melting point. For example, Patent document 2 proposes a Sn-base alloy containing elements of the 3B, the 4B and the 5B group. Patent document 3 proposes An A-M alloy, in which A is Si or Sn, M is Al, Ag, Au, Zn, Yi, Ni, Cu, Co, Ta, Fe, W, Cr, V, Ga, Pb, Mo, In or Te, and containing M in a content between 0.02 and 0.8 at %.

An optical recording medium using the interlayer reaction recording method and proposed in Patent document 4 is provided with a first recording layer of In—O—(Ni, Mn, Mo) and a second recording layer containing Se and/or Te—O—(Ti, Pd, Zr). An optical recording medium proposed in Patent document 5 is provided with a first recording layer of a metal containing In as a principal component and a second recording layer containing a metal other than an oxide containing an element of the 5B or the 6B group, or a metalloid.

When a disk is provided with an oxide recording film, the disk needs a reflecting film to enhance reflectivity because the oxide recording film has a low reflectivity and needs dielectric films of ZnS—SiO₂ or the like formed, respectively, over and under the recording film to enhance modulation factor. Thus, this disk needs many films.

A recording film used by the hole creating method that forms pits in a metal thin film having a low melting point has high reflectivity and can obtain a high modulation factor by pitting. Thus, this method is advantageous from the viewpoint of reducing the number of films needed by the disk. Generally, metal thin films are inferior to oxide films and nitride films in heat resistance at high temperatures. Therefore, various improvements using alloying are studied. However, there is a problem in balancing characteristics because alloying reduces reflectivity and changes the characteristics of disks.

Patent document 1: Jpn. Pat. No. 3638152

Patent document 2: JP-2002-225433 A

Patent document 3: U.S. Pat. Pub. 2004/0241376

Patent document 4: JP 2003-326848 A

Patent document 5: Jpn. Pat. No. 3499724

### DISCLOSURE OF THE INVENTION

The present invention has been made to solve the foregoing problems in the prior art and to provide a recording layer (recording film), for an optical recording medium, having a high reflectivity (initial reflectivity) and capable of achieving a high C/N ratio and of reducing jitter, an optical recording medium provided with the recording layer, and a sputtering target for forming a recording layer for the optical recording medium.

The inventors of the present invention made studies and experiments for the development of a recording film having high recording sensitivity to a violet laser beam of the next generation for the hole creating method, thought of using In having a low melting point and not placing heavy load on the environment as a base metal of an alloy and found that the foregoing problems can be favorably solved by adding at least one of Sn, Bi, Ge and Si to the alloy. The present invention has been made on the basis of such a finding.

The present invention relates to the following items (1) to (5).

(1) A recording layer, for an optical recording medium, capable of forming recording marks when irradiated with a laser beam and made of an In-base alloy containing Ni and/or Co in a content in the range of 20 to 65 at %.

(2) The In-base alloy forming the recording layer stated in (1), for an optical recording medium, further containing at least one of Sn, Bi, Ge and Si in a content of 19 at % or below excluding 0 at %.

(3) An optical recording medium provided with the recording layer stated in (1) or (2)

(4) A sputtering target, for forming a recording layer of an optical recording medium, made of an In-base alloy containing Ni and/or Co in a content in the range of 20 to 65 at %.

(5) The In-base alloy, forming the sputtering target for forming a recording layer of an optical recording medium, stated in (4) further containing at least one of Sn, Bi, Ge and Si in a content of 19 at % or below excluding 0 at %.

The present invention provides a recording layer, for an optical recording medium, having excellent characteristics including a high reflectivity (initial reflectivity) and capable of achieving a high C/N ratio and of reducing jitter, and an optical recording medium. The optical recording medium is most suitable for use as a write-once optical disk having a small number of films in which information is recorded by a hole creating method using a violet laser beam. The present invention provides a sputtering target effective in forming the recording layer and the optical recording medium.

### BRIEF DESCRIPTION OF THE DRAWINGS

FIG. 1 is a typical sectional view of an optical disk in a preferred embodiment according to the present invention and in an example.

### REFERENCE CHARACTERS

1: Substrate, 2: Recording layer, and 3: Transparent layer

### BEST MODE FOR CARRYING OUT THE INVENTION

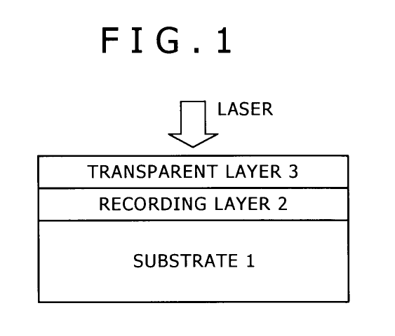

FIG. 1 is a typical sectional view of an optical disk in a preferred embodiment according to the present invention and in an example. Shown in FIG. 1 are a substrate 1, a recording layer 2 and a transparent layer 3.

Description will be made of grounds for selecting In as a principal component (base metal) of the recording layer 2 of the present invention, and for using an In-base alloy containing Ni and/or Co, and at least one of Sn, Bi, Ge and Si.

Indium (In) is used as a principal component because the melting point of about 156.6° C. of In is far lower than those of other metals, such as Al, Ag and Cu, and hence an In-base alloy film melts and deforms easily and is capable of exhibiting an excellent recording characteristic even if a low-power recording laser beam is used. Whereas it is conjectured that formation of recording marks in a recording layer of an Al-base alloy is difficult, a recording layer of an In-base alloy does not have such a problem at all when the recording layer is intended for application to an optical disk of the next generation to which information is written with a low-power violet laser beam. To make the In-base alloy fully exercise such a satisfactory recording characteristic, it is preferable that the In-base alloy has an In Content of 30 at % or above, desirably, 45 at % or above, more desirably, 50 at % or above.

The present invention adds Ni and/or Co to In in a content in the range of 20 to 65 at % to achieve a high C/N ratio with 8T signals maintaining high reflectivity. Although the precise mechanism of the effect of the addition of Ni or Co is not clearly known, it is conjectured that the formation of a film having a very smooth surface, formation of a minute structure and surface tension adjustment can be simultaneously achieved by adding Ni and/or Co to the In-base alloy. Preferably, a lower limit Ni and/or Co content of the In-base alloy is 20 at %, desirably, 30 at %, more desirably, 40 at %. Preferably, an upper limit Ni and/or Co content of the In-base alloy is 56 at %, desirably, 50 at %, more desirably, 45 at %. Preferably, the Ni content of the In-base alloy when only Ni is added to the In-base alloy is in the range of 20 to 45 at %, desirably, 25 to 35 at %. Preferably, the Co content of the In-base alloy when only Co is added to the In-base alloy is in the range of 35 to 56 at %, desirably, 40 to 56 at %.

When the Ni and/or Co content is below 20 at %, formation of a recording film having a very smooth surface cannot be achieved, media noise increases and a high C/N ratio cannot be achieved. Thus, such an excessively low Ni and/or Co content is undesirable. When the Ni and/or Co content is above 65 at %, the advantageous effect of the low melting point of In is significantly nullified, recording sensitivity is deteriorated, i.e., the power of a recording laser beam to achieve a high C/N ratio increases. Thus, such an excessively high Ni and/or Co content is undesirable.

From the viewpoint of reducing jitter, addition of both Ni and Co to the In-base alloy is more desirable than the addition of Ni or Co to the In-base alloy.

Although Pt and Au as additive elements other than Ni and Co are effective in forming a recording film having a very smooth surface, Pt and Au reduces reflectivity drastically as compared to Ni or Cu and hence satisfactory reflectivity cannot be ensured. Although a recording film containing V is satisfactory in reflectivity, the recording film is inferior to a recording film containing Ni or Co in surface smoothness and cannot achieve a satisfactorily high C/N ratio.

Jitter can be reduced by adding at least one of Sn, Bi, Ge and Si in a content of 19 at % or below to an In-base alloy containing Ni and/or Co in a content in the range of 20 to 65 at %. Although the precise mechanism of the effect of the addition of one of Sn, Bi, Ge and Si is not clearly known, it is conjectured that Sn, Bi, Ge and Si control the lateral spread of heat due to low thermal conductivity without raising the melting point. Preferably, a lower limit to a content in which the In-base alloy contains at least one of Sn, Bi, Ge and Si is 1 at %, desirably, 5 at %. Preferably, an upper limit to a content in which the In-base alloy contains at least one of Sn, Bi, Ge and Si is 19 at %, desirably, 11 at %, more desirably, 10 at %.

An optimum thickness of the recording layer is dependent on other layers of metals, metalloids or dielectrics. When any other layers are not formed, it is preferable that the thickness of the recording layer is in the range of 8 to 25 nm, desirably, in the range of 10 to 20 nm.

The present invention is not limited to a recording layer of single-layer structure and may be a recording layer of two-layer structure including a light-absorbing layer sandwiched between a transparent layer (cover layer) and a recording layer or a recording layer of two-layer structure including a wettability control layer sandwiched between a substrate and a recording layer to meet required reflectivity, recording characteristic and durability.

Preferably, the recording layer of the foregoing In-base alloy is formed by a sputtering process because the sputtering process has capability to form the recording layer in a uniform thickness on a surface of a disk.

Basically, the composition of a sputtering target for forming the foregoing recording layer of the present invention is the same as that of the alloy forming the recording layer. A desired composition can be readily realized by adjusting the composition to that of the In-base alloy mentioned above.

The sputtering target is made by a vacuum melting method or the like. In some cases, the sputtering target is contaminated with gases contained in the ambient atmosphere, such as nitrogen gas and oxygen gas, and a very small amount of components of the material of a melting furnace as impurities. The respective compositions of the recording layer and the sputtering target of the present invention do not prescribe those minor components inevitably contained in the recording layer and the sputtering target. The recording layer and the sputtering target may contain those inevitable impurities in a very small content, provided that the foregoing characteristic of the present invention is not deteriorated.

### EXAMPLES

Examples of the present invention and comparative examples will be described. The present invention is not limited to the following examples and proper changes and variations may be made therein within the scope of the present invention and those changes and variations are included in the technical scope of the present invention.

1) Method of Fabricating Optical Disk

A polycarbonate substrate having a thickness of 1.1 mm, track pitches of 0.32 μm, a groove width in the range of 0.14 to 0.16 μm and a groove depth of 25 nm was used as a substrate 1. A recording layer 2 was formed on a surface of the substrate 1 by a dc magnetron sputtering process. The dc magnetron sputtering process used a composite target formed by placing an additive element chip of 5 mm sq. or 10 mm sq. on a 6 in. diameter In target as a sputtering target. The composition of a film thus formed was determined by ICP emission spectrophotometry or ICP mass spectrometry.

Sputtering conditions are an ultimate vacuum of 3×10⁻⁶ Torr, an Ar gas pressure of 2 mTorr and dc sputtering power of 100 W. The recording layer 2 was formed in a thickness in the range of 12 to 21 nm such that the level of a SUM2 signal, namely, an output signal correlated with reflectivity, from an unrecorded BD-R disk is ensured to be 280 mV or above. (Some alloys in comparative examples could not ensure the level of 280 mV.)

Then, the recording layer 2 was coated with a film of an ultraviolet-curable resin (BRD-130, registered trademark of Nippon Kayaku Co., Ltd.) by a spin coating process, and the film was cured by ultraviolet irradiation to form a transparent layer 3 of a thickness of 100±15 μm. The evaluation of an optical disk used an optical disk tester (ODU-1000, registered trademark of Pulstec Industrial Co., Ltd.) using a recording laser beam having a wavelength of 405 nm and a NA (numerical aperture) of 0.85, and a spectrum analyzer (R3131R, registered trademark of ADVANTEST CORPORATION). A recording mark of 0.6 μm in length, which corresponds to the 8T signal of a 25 GB blu-ray disk, was formed repeatedly at a linear speed of 4.9 m/s at a SUM2 level in an unrecorded state with a recording laser beam of power in the range of 4 to 12 mW. A maximum C/N ratio during signal reading using a reading laser beam of 0.3 mW was measured. Jitter occurred when recording marks of lengths between a shortest length of 0.15 μm and a longest length of 0.6 μm at pitches of 0.075 μm, which corresponds to the 2T to 8T signals of a 25 GB Blu-ray disk, were formed randomly with a recording laser beam of power between 4 and 12 mW was evaluated by a time interval analyzer (TA520, registered trademark of Yokogawa Electric Corporation). Jitter is an index of the indefiniteness of the positions of edges of recorded signal marks and corresponds to the dispersion σ of a normal distribution of positions of the leading and the trailing edges of recorded marks. The jitter of signals recorded on the middle one of three continuous tracks when signals were recorded on those three continuous tacks, namely, jitter during continuous three-track recording, was evaluated. At the same time, laser power at which the jitter was a minimum during continuous three-track recording was determined.

Table 1 shows levels of SUM2 in an unrecorded state and C/N ratios in recording 8T signals on and reproducing 8T signals from optical recording mediums in examples and comparative examples. Table 2 shows levels of SUM2 in an unrecorded state, C/N ratios in recording 8T signals on and reproducing 8T signals from the optical recording mediums in examples and comparative examples, values of recording power needed to minimize jitter during continuous three-track recording, and jitters during continuous three-track recording. Data shown in Table 1 are those on the optical recording mediums respectively provided with recording layers meeting conditions stated in (1). Data shown in Table 2 are those on the optical recording mediums respectively provided with recording layers meeting conditions stated in (2). Values of power of recording laser beam at which the C/N ratio was a maximum were in the range of 6 to 10 mW. In Tables 1 and 2, levels of SUM2 in an unrecorded state not lower than 280 mV are marked with a circle, levels of SUM2 in an unrecorded state below 280 mV are marked with a cross, values of C/N ratio not lower than 50 dB during recording and reproducing 8T signals are marked with a circle, and values of C/N ratio below 50 dB during recording and reproducing 8T signals are marked with a cross.

TABLE 1

| | Type of alloy | Composition (ICP) | Ni + Co | Thickness | SUM2 | | 8T C/N | |
|---|---|---|---|---|---|---|---|---|
| Example 1 | In—Co | Co 22at % | 22at % | 12 nm | ◯ | 317 mV | ◯ | ≧50 dB |
| Example 2 | In—Co | Co 36.2at % | 36.2at % | 12 nm | ◯ | 310 mV | ◯ | ≧50 dB |
| Example 3 | In—Co | Co 36.2at % | 36.2at % | 15 nm | ◯ | 318 mV | ◯ | ≧50 dB |
| Example 4 | In—Co | Co 40.8at % | 40.8at % | 12 nm | ◯ | 331 mV | ◯ | ≧50 dB |
| Example 5 | In—Co | Co 40.8at % | 40.8at % | 15 nm | ◯ | 355 mV | ◯ | ≧50 dB |
| Example 6 | In—Co | Co 43.0at % | 43.0at % | 14 nm | ◯ | 341 mV | ◯ | ≧50 dB |
| Example 7 | In—Co | Co 55.6at % | 55.6at % | 13 nm | ◯ | 338 mV | ◯ | ≧50 dB |
| Example 8 | In—Co | Co 55.6at % | 55.6at % | 15 nm | ◯ | 396 mV | ◯ | ≧50 dB |
| Example 9 | In—Co | Co 65.1at % | 65.1at % | 18 nm | ◯ | 379 mV | ◯ | ≧50 dB |
| Example 10 | In—Co | Co 65.1at % | 65.1at % | 20 nm | ◯ | 411 mV | ◯ | ≧50 dB |
| Example 11 | In—Ni | Ni 34at % | 34at % | 15 nm | ◯ | 341 mV | ◯ | ≧50 dB |
| Example 12 | In—Ni—Co | Ni 11at % Co 14at % | 25at % | 15 nm | ◯ | 295 mV | ◯ | ≧50 dB |
| Example 13 | In—Ni—Co | Ni 17at % Co 10at % | 27at % | 15 nm | ◯ | 306 mV | ◯ | ≧50 dB |
| Example 14 | In—Ni—Co | Ni 28at % Co 10at % | 38at % | 18 nm | ◯ | 330 mV | ◯ | ≧50 dB |
| Example 15 | In—Ni—Co | Ni 29at % Co 8at % | 37at % | 21 nm | ◯ | 283 mV | ◯ | ≧50 dB |
| Example 16 | In—Ni—Co | Ni 7at % Co 17at % | 24at % | 15 nm | ◯ | 355 mV | ◯ | ≧50 dB |
| Example 17 | In—Ni—Co | Ni 22at % Co 13at % | 35at % | 15 nm | ◯ | 341 mV | ◯ | ≧50 dB |
| Comparative | In—Pt | Pt 16.6at % | — | 21 nm | X | 205 mV | X | 44 dB |
| example 1 | | | | | | | | |
| Comparative | In—Au | Au 12.5at % | — | 21 nm | X | 155 mV | X | 29 dB |
| example 2 | | | | | | | | |
| Comparative | In—V | V 14.2at % | — | 18 nm | ◯ | 325 mV | X | 36 dB |
| example 3 | | | | | | | | |
| Comparative | In—Co | Co 67.1at % | 67.1at % | 16 nm | ◯ | 412 mV | X | 47.1 dB |
| example 4 | | | | | | | | |

TABLE 2

| | | | | | | | | Power of | |
|---|---|---|---|---|---|---|---|---|---|
| | | | | | | | | recording | |
| | Type of alloy | Composition (IP) | Thickness | SUM2 | | 8T C/N | | laser beam | Jitter |
| Example 18 | In—Co | Co 55.6at % | 13 nm | ◯ | 338 mV | ◯ | ≧50 dB | 7.1 mW | 8.4% |
| Example 19 | In—Co | Co 65.1at % | 18 nm | ◯ | 379 mV | ◯ | ≧50 dB | 8.0 mW | 11.6% |
| Example 20 | In—Co—Sn | Co 46.1at % Sn 1.05at % | 12 nm | ◯ | 291 mV | ◯ | ≧50 dB | 6.6 mW | 7.8% |
| Example 21 | In—Co—Sn | Co 47.1at % Sn 1.75at % | 12 nm | ◯ | 289 mV | ◯ | ≧50 dB | 6.0 mW | 7.9% |
| Example 22 | In—Co—Bi | Co 29at % Bi 19at % | 15 nm | ◯ | 310 mV | ◯ | ≧50 dB | 7.4 mW | 8.6% |
| Example 23 | In—Ni—Sn | Ni 31at % Sn 15at % | 15 nm | ◯ | 311 mV | ◯ | ≧50 dB | 7.8 mW | 8.8% |
| Example 24 | In—Ni—Sn | Ni 35at % Sn 15at % | 15 nm | ◯ | 365 mV | ◯ | ≧50 dB | 7.6 mW | 10.1% |
| Example 25 | In—Ni—Sn | Ni 37at % Sn 17at % | 15 nm | ◯ | 335 mV | ◯ | ≧50 dB | 8.0 mW | 9.9% |
| Example 26 | In—Co—Bi | Co 39at % Bi 10at % | 12 nm | ◯ | 280 mV | ◯ | ≧50 dB | 7.2 mW | 9.5% |
| Example 27 | In—Co—Ge | Co 50.4at % Ge 7.4at % | 14 nm | ◯ | 340 mV | ◯ | ≧50 dB | 6.4 mW | 9.0% |
| Example 28 | In—Co—Si | Co 42.8at % Si 6.4at % | 15 nm | ◯ | 351 mV | ◯ | ≧50 dB | 7.2 mW | 8.7% |
| Example 29 | In—Co—Ni—Sn | Co 37.4at % Ni 9.2at % | 12 nm | ◯ | 344 mV | ◯ | ≧50 dB | 6.6 mW | 6.9% |
| | | Sn 4.7at % | | | | | | | |
| Example 30 | In—Co—Ni—Sn | Co 36.5at % Ni 10.7at % | 12 nm | ◯ | 353 mV | ◯ | ≧50 dB | 6.4 mW | 7.3% |
| | | Sn 9.8at % | | | | | | | |
| Example 31 | In—Co—Ni—Sn | Co 41.4at % Ni 8.5at % | 12 nm | ◯ | 309 mV | ◯ | ≧50 dB | 6.4 mW | 6.9% |
| | | Sn 8.4at % | | | | | | | |
| Example 32 | In—Co—Ni—Sn | Co 34.0at % Ni 16.6at % | 12 nm | ◯ | 308 mV | ◯ | ≧50 dB | 6.2 mW | 6.9% |
| | | Sn 5.7at % | | | | | | | |
| Example 33 | In—Co—Ni—Sn | Co 34.1at % Ni 13.2at % | 13 nm | ◯ | 346 mV | ◯ | ≧50 dB | 6.6 mW | 7.4% |
| | | Sn 10.9at % | | | | | | | |
| Example 34 | In—Co—Ni—Sn | Co 32.5at % Ni 10.7at % | 14 nm | ◯ | 354 mV | ◯ | ≧50 dB | 6.6 mW | 7.4% |
| | | Sn 5.2at % | | | | | | | |
| Example 35 | In—Co—Ni—Sn | Co 34.2at % Ni 14.7at % | 14 nm | ◯ | 312 mV | ◯ | ≧50 dB | 6.6 mW | 8.1% |
| | | Sn 3.8at % | | | | | | | |
| Example 36 | In—Co—Ni—Sn | Co 32.2at % Ni 12.5at % | 11 nm | ◯ | 286 mV | ◯ | ≧50 dB | 6.2 mW | 7.8% |
| | | Sn 7.1at % | | | | | | | |
| Example 37 | In—Co—Ni—Sn | Co 34.4at % Ni 17.5at % | 13 nm | ◯ | 333 mV | ◯ | ≧50 dB | 6.6 mW | 7.8% |
| | | Sn 5.3at % | | | | | | | |
| (Example 1) | In—Co | Co 22at % | 12 nm | ◯ | 317 mV | ◯ | ≧50 dB | 6.8 mW | 11.6% |

It is known from Table 1 that all the levels of SUM2 and all the C/N ratios of the optical disks provided with the recording layers of In-base alloys containing Ni and/or Co are higher than those of the optical disks in comparative examples provided with the recording layers of In-base alloys containing Pt, Au or V. The optical disks provided with the recording layers of In-base alloys containing Ni and/or Co have an excellent recording characteristic.

It is known from Table 2 that all the levels of SUM2 and all the C/N ratios of the optical disks provided with the recording layers of In-base alloys containing Ni and/or Co, and at least one of Bi, Sn, Ge and Si are high. It is known also that jitters of the optical disks provided with recording layers each of the In-base alloy containing Ni and/or Co, and at least one of Bi, Sn, Ge and Si are lower than those of a reference example corresponding to Example 1 provided with a recording layer not containing any one of Bi, Sn, Ge and Si. Thus, the optical disks provided with the recording layer of the In-base alloy containing Ni and/or Co, and at least one of Bi, Sn, Ge and Si has an excellent recording characteristic.

Although the present invention has been described in its specific examples, it is obvious to those skilled in the art that changes and modifications are possible therein without departing from the scope and spirit of the present invention.

The present invention contains subject matters related to Jpn. Pat. App. 2006-215754 filed on Aug. 8, 2006, Jpn. Pat. App. 2007-029612 filed on Feb. 8, 2007 and Jpn. Pat. App. 2007-126210 filed on May 11, 2007, the entire contents of which are incorporated herein by reference.

### INDUSTRIAL APPLICABILITY

The present invention provides the recording layer having excellent characteristics including a high reflectivity, a high C/N ratio and a low jitter for an optical recording medium, and the optical recording medium. The optical recording medium is an optimum write-once optical disk having a small number of films to which information is written by a hole creating method using a violet laser beam. The present invention provides the sputtering target effective in forming the recording layer and in fabricating the optical recording medium.

1. A recording layer, for an optical recording medium, capable of forming recording marks when irradiated with a laser beam and made of an In-based alloy comprising Ni and/or Co in the range of 20 to 65 at %.

2. The recording layer, for an optical recording medium, according to claim 1, wherein the In-based alloy further comprises at least one of Sn, Bi, Ge and Si in a content of 19 at % or below but greater than 0 at %.

3. An optical recording medium provided with the recording layer stated in claim 1.

4. A sputtering target, for forming a recording layer of an optical recording medium, made of an In-based alloy comprising Ni and/or Co in the range of 20 to 65 at %.

5. The sputtering target, for forming a recording layer of an optical recording medium, according to claim 4 further comprising at least one of Sn, Bi, Ge and Si in a content of 19 at % or below but greater than 0 at %.
